(19) United States
(12) Patent Application Publication
(10) Pub. No.: US 2015/0178401 A1
(43) Pub. Date: Jun. 25, 2015

(54) METHODS AND SYSTEMS FOR IDENTIFYING STRANDED CAPACITY

(71) Applicant: Panduit Corp., Tinley Park, IL (US)

(72) Inventor: Robert E. Wilcox, SR., Monee, IL (US)

(73) Assignee: Panduit Corp., Tinley Park, IL (US)

(21) Appl. No.: 14/573,560

(22) Filed: Dec. 17, 2014

Related U.S. Application Data
(60) Provisional application No. 61/918,062, filed on Dec. 19, 2013.

(51) Int. Cl. G06F 17/30

(52) U.S. Cl. CPC G06F 17/30876

(57) ABSTRACT

Embodiments of the present invention are directed towards systems and methods for managing environmental variables associated with electronic equipment within a datacenter. In an embodiment, the present invention is a data center physical infrastructure management system that is managed by IT personnel. The system comprises at least one of a rack and a cabinet having rack spaces and at least one sensor, a data communication arrangement for propagating communications signals from the sensor to a management database that receives information from the communications signals, the received information being stored, and a data processor for determining algorithmically, from the received information, stranded capacity within the at least one of a rack and a cabinet.

### CROSS-REFERENCE TO RELATED APPLICATIONS

This application claims the benefit of U.S. Provisional Patent Application No. 61/918,062 filed on December 19, 2013, which is incorporated herein by reference in its entirety.

### BACKGROUND

Since the early development of computer networks, data centers have played a significant role in the exchange of electronic information as they often act as repositories for stored information or hubs which facilitate the flow-through of electronic traffic from one location to another. While initially such data centers were often the domain of large-scale operations such as internet service providers, today data centers take on a wide variety of shapes and sizes, and can be found in use in many different industries. For example, environments where data centers may be found can include everything from small office buildings to large corporations, major search engines and social media operators, and internet and multimedia providers.

In addition, data centers today must handle an ever increasing amount of electronic traffic with commensurate speed and efficiency. The ability to satisfy this need generally comes by way of relying on powerful hardware which often consumes large amounts of power, requires sufficient connectivity, takes up various amounts of space, and produces considerable amount of heat. Coupled with the fact that this type of hardware is expensive to purchase, install, and maintain, efficient management of data centers which house the hardware in question can be considered an essential component of the overall data center operations to data center managers or other users.

U.S. Pat. No. 8,306,935 (Doorhy et al.), which is incorporated herein by reference in its entirety, describes a data center infrastructure management (DCIM) system which includes systems and methods that allow for the discovery of physical location information about network assets and the delivery of that information to network administrators. In addition, environmental and other information about network asset locations can be provided to an administrator. Intelligent patch panels and power outlet units can be installed in network cabinets to facilitate the acquisition and reporting of physical infrastructure information, including information about network resource availability. The system of Doorhy et al. '935 can include software that can reside on a server or other computer, where the software may interact with a variety of equipment (switches, servers, intelligent patch panels, power outlet units, network cabinets, gateways, sensors, etc.) and software to provide the functional benefits of the Doorhy et al. '935 system.

Additionally, U.S. Patent Application Publication No. 2012/0133510 (Pierce et al.), which is incorporated herein by reference in its entirety, describes a DCIM system with a cabinet having rack spaces and at least one sensor. A data communication system transmits signals to a management database such as may be available in Doorhy et al. '935. Removable electronic assets contained in the rack spaces can each have an identifier tag, and an identifier tag reader may be installed on the cabinet body.

Through the use of systems such as those disclosed in Doorhy et al. '935 and Pierce et al. '510 much useful information on network assets/resources may be obtained. However, one of the challenges of efficient network utilization is maximizing the availability of network asset/resource capacities for product purposes.

Although the systems of Doorhy et al. '935 and Pierce et al. '510 may provide useful information on network assets/resources, or some of the above information (such as rack space) may be available by visual observation, given the fact that many data centers are generally relatively large and complex facilities, such information may not be easily accessible or it may not be in a manageable format that can easily provide information pertaining to utilization of network asset/resource capacities. Additionally, unused categorical capacities in a given data center subsystem, such as a rack or cabinet of equipment, may not generally be available for a data center manager.

### SUMMARY

In an embodiment, the present invention is a data center physical infrastructure management system that is managed by IT (Information Technology) personnel. The system comprises at least one of a rack and a cabinet having rack spaces and at least one sensor, a data communication arrangement for propagating communications signals from the sensor to a management database that receives information from the communications signals, the received information being stored, and a data processor for determining algorithmically, from the received information, stranded capacity within the at least one of a rack and a cabinet.

In another embodiment, the present invention is a method for determining stranded capacity within a data center, the method using at least one processor connected to at least one database, the at least one database including locations for data center assets and capacities. The method includes the steps of: (1) recording a plurality of stranded capacity threshold values in at least one of a memory and the at least one database; (2) retrieving a plurality of the locations for data center assets and capacities; (3) comparing each of the locations for data center assets and capacities with each of the stranded capacity threshold values; (4) determining, for each of the locations, if the comparing step yields at least one insufficient capacity in any of the respective locations; and (5) checking, for each of the locations wherein the determining step identified at least one insufficient capacity, if the comparing step yields at least one sufficient capacity in respective the each of the locations.

In yet another embodiment, the present invention is a system for determining stranded capacity within a data center, the data center including locations for data center assets and capacities. The system comprises at least one processor, at least one database connected to the at least one processor, and at least one computer readable medium connected to the at least one processor, the at least one computer readable medium including instructions for recording a plurality of stranded capacity threshold values in the at least one database, retrieving a plurality of the locations for data center assets and capacities, comparing each of the locations for data center assets and capacities with each of the stranded capacity threshold values, determining, for each of the locations, if the comparing step yields at least one insufficient capacity in any of the respective locations, and checking, for each of the locations wherein the determining step identified at least one insufficient capacity, if the comparing step yields at least one sufficient capacity in respective the each of the locations.

These and other features, aspects, and advantages of the present invention will become better-understood with reference to the following drawings, description, and any claims that may follow.

### BRIEF DESCRIPTION OF THE DRAWINGS

FIG. 1 illustrates examples of stranded capacity.

FIG. 2 illustrates a schematic structure of a system according to an embodiment of the present invention.

FIG. 3 illustrates a stranded capacity search screen according to an embodiment of the present invention.

FIG. 4 illustrates stranded capacity search results according to an embodiment of the present invention.

FIG. 5 illustrates a flowchart representative of an algorithm for carrying out a method according to an embodiment of the present invention.

FIG. 6 illustrates a corresponding truth table for the algorithm of FIG. 5.

FIG. 7 illustrates an example of system flow diagram according to an embodiment of the present invention.

### DETAILED DESCRIPTION

In at least some embodiments, the present invention is a method and system for identifying stranded capacity in a datacenter. The method according to the present invention implements a software tool for identification of the stranded capacity which may assist with this otherwise complicated and tedious identification task.

Network asset/resource capacities that may not be available for productive purposes may be considered stranded capacities. Such a capacity can be identified as network asset/resource capacity that cannot be utilized by IT loads/demand due to the design or configuration of the data center. The presence of stranded capacity in a data center typically indicates an imbalance between two or more of the following capacities: floor and rack space, power, cooling and connectivity.

A specific IT device typically requires sufficient capacity of all of the four above elements. Yet these elements are almost never available in an exact balance of capacity to match a specific IT load. Typically there are locations with rack space but without available cooling, or spaces with available power but with no available rack space. Available capacity of one type that cannot be used because one of the other three capacities listed above has been used to its maximum capacity is called stranded capacity. Stranded capacity is undesirable at least because it is an indication of inefficient resource utilization and can seriously limit the performance of a data center.

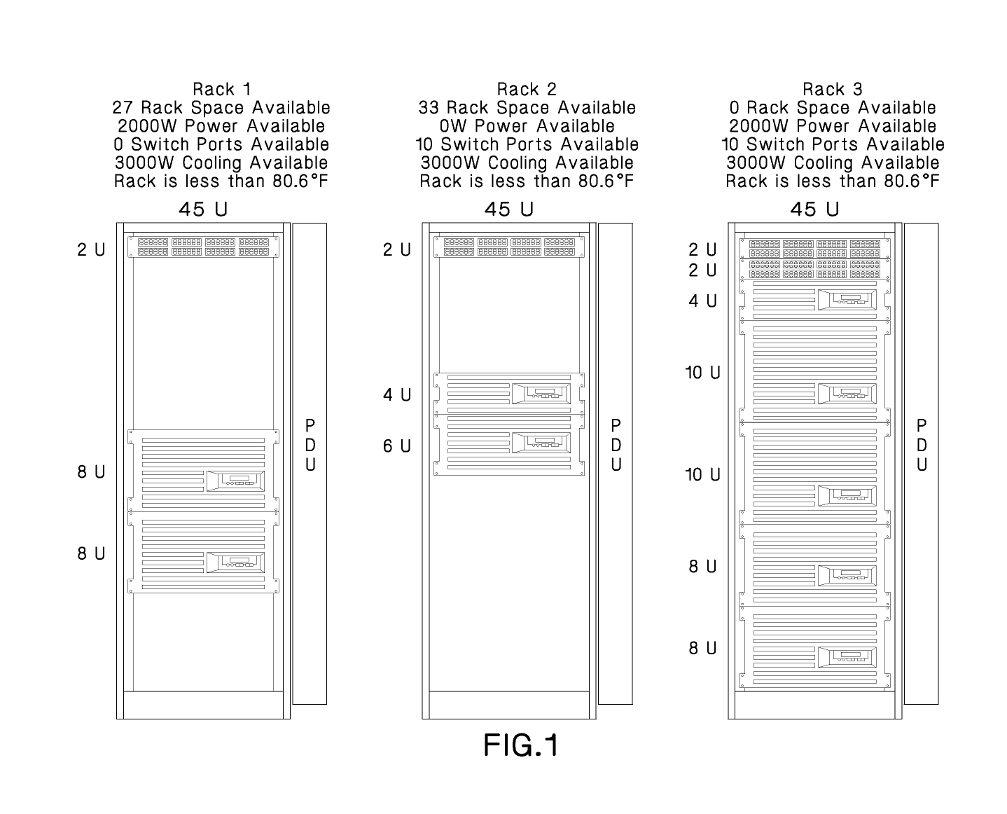

FIG. 1 illustrates some examples of stranded capacity within a data center. For example, stranded capacity for rack space can be defined by the user to exist if at least one of these conditions are met: 0 Rack spaces, 100 W or less power availability, 0 port availability, and a temp over 80.6 degrees F.; and if at least one of the same conditions are not met. Under these conditions, all three racks in FIG. 1 are determined to have stranded capacity. In FIG. 1, stranded capacity can be displayed in green and capacity that is causing the stranding can be shown in red. In Rack 1, 27 rack spaces, 2000 W of power, and 3000 W of cooling (alternatively, rack temperature is below 80.6 degrees) are stranded because there are no switch ports available. In Rack 2, 33 rack spaces, 10 Switch ports, and 3000 W of cooling (alternatively, rack temperature is under 80.6 degrees) are stranded because there is no available power in the rack. In Rack 3, 2000 W of power, 10 switch ports, and 3000 W of cooling (alternatively rack is less than 80.6 degrees), are stranded because there are no rack spaces available.

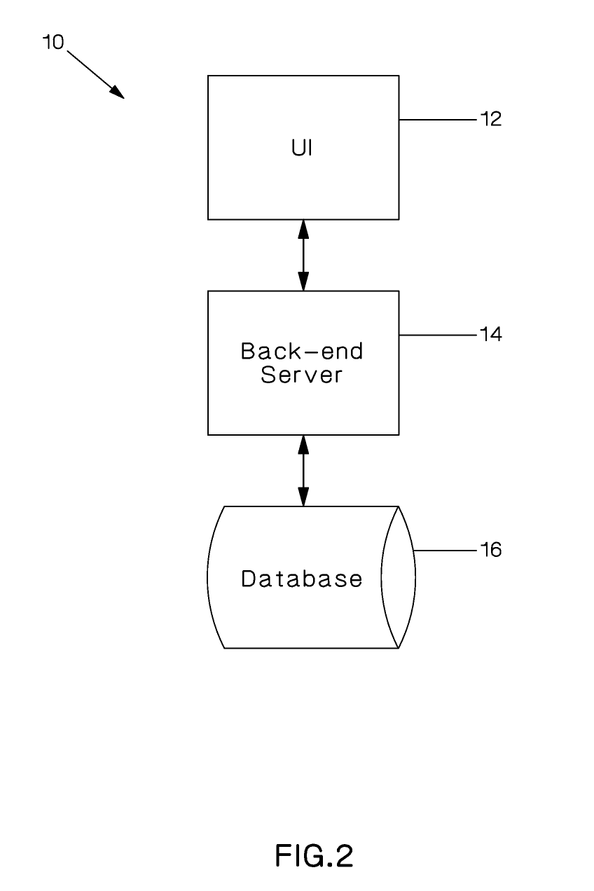

Referring to FIG. 2, a software tool 10 according to an embodiment of the present invention may have at least three parts: a user interface 12, a back-end server 14, and a database 16. User interface 12 allows a user to interact with a back-end server 14 for at least the purpose of searching for stranded capacity. Back-end server 14 includes at least some data center business intelligence and carries out instructions from the user via user interface 12, including searching for stranded capacity within database 16. Database 16 stores information related to capacities of the current data center configuration at a minimum and back-end server 14 interacts with database 16 to read and write information. User interface (UI) 12, back-end server 14, and database 16 can be elements of the systems of Doorhy et al. '935 and Pierce et al. '510 and/or interface with the systems of Doorhy et al. '935 and Pierce et al. '510, and/or be used by the systems of Doorhy et al. '935 and Pierce et al. '510.

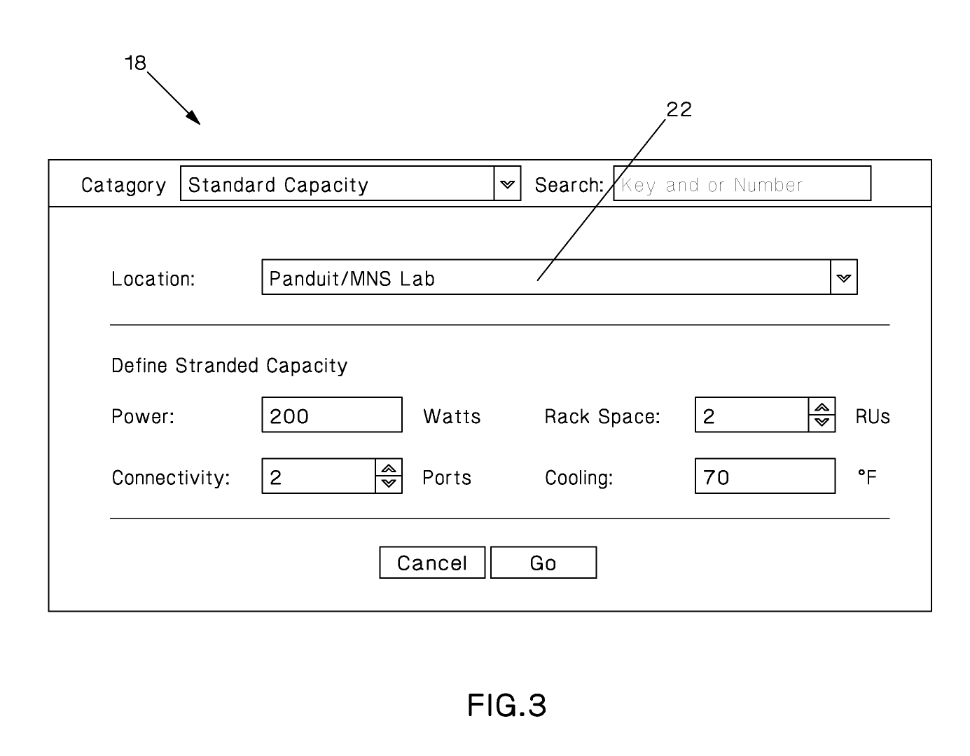

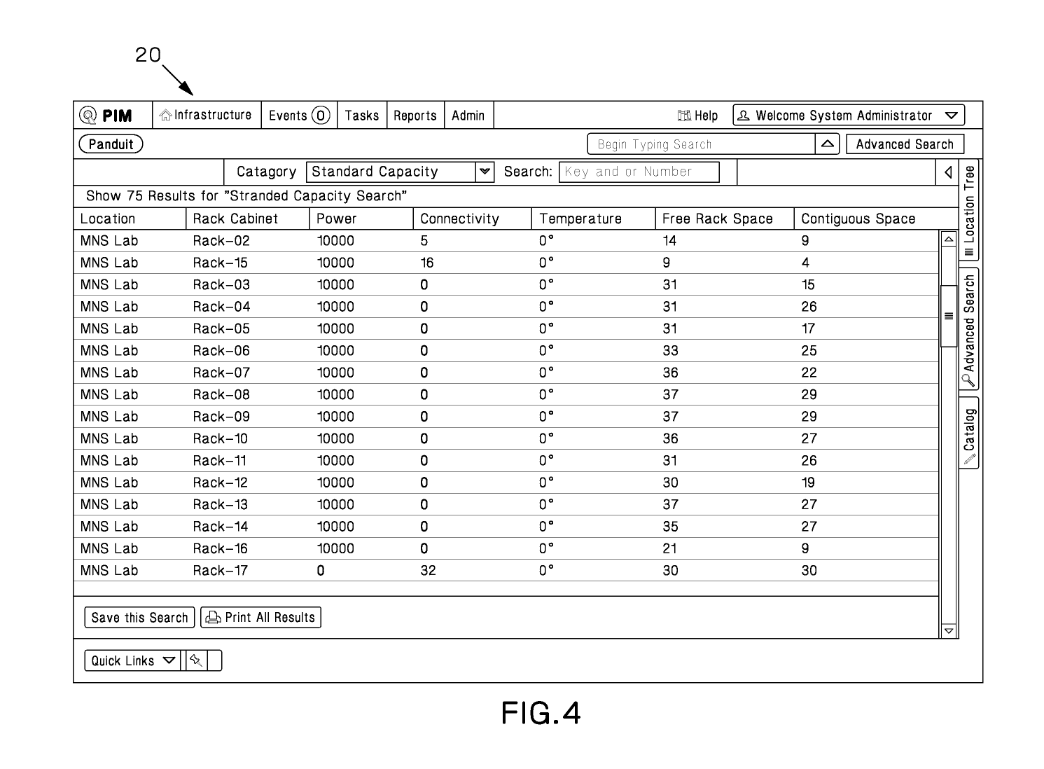

A stranded capacity search screen 18 (FIG. 3) and a stranded capacity search results screen 20 (FIG. 4) can be included in at least one embodiment of the present invention. Stranded capacity search screen 18 is a graphical user interface (GUI) which allows a user to define the thresholds for useable capacity.

Stranded capacity can be defined as a remaining available capacity that cannot be due to an exhaustion of another variable that is associated in some way with the remaining available capacity (e.g., having excess power but being unable to utilize it because no rack space is available.). However, the point at which capacity becomes stranded depends on what is being implemented within the data center. For example, if a user is implementing 1000 W servers, then any cabinet with less than 1000 W of power has the potential to have stranded capacity if they have the necessary rack space, connectivity, or cooling. Stranded capacity search screen 18 allows a user to define thresholds for useable capacity according to the specific needs/configuration of a data center or data center modification. The user can also use a location filter 22 to define which data centers or which portions of a data center to search for stranded capacity. Additional filters may be created as needed, such as security, for example.

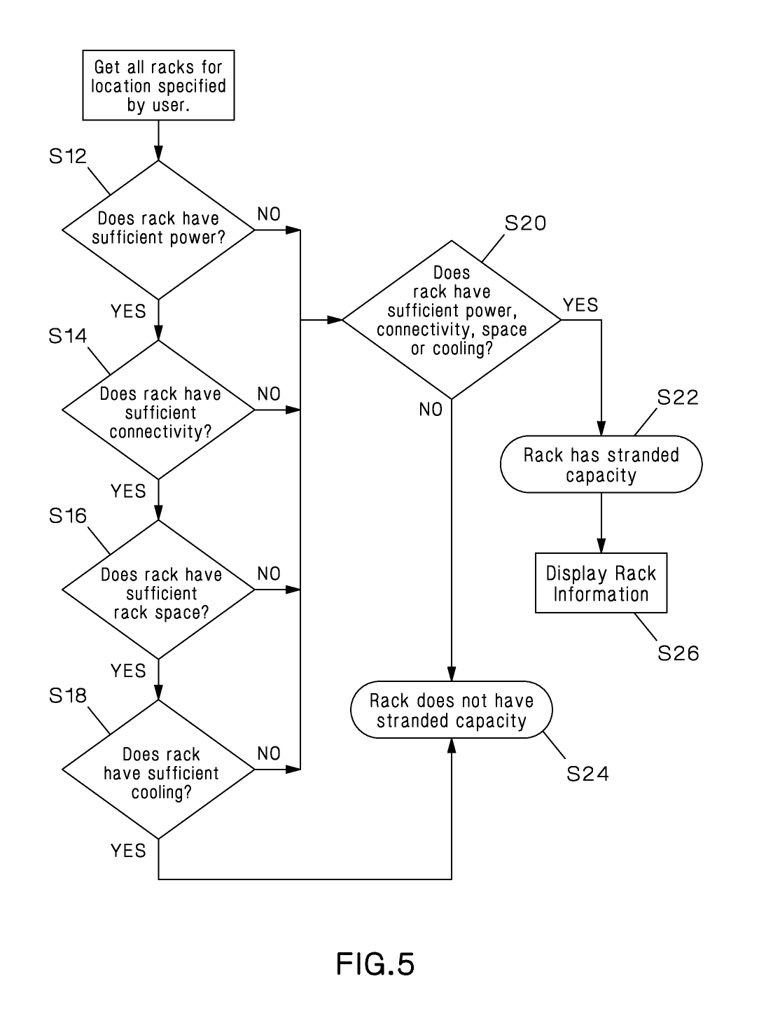

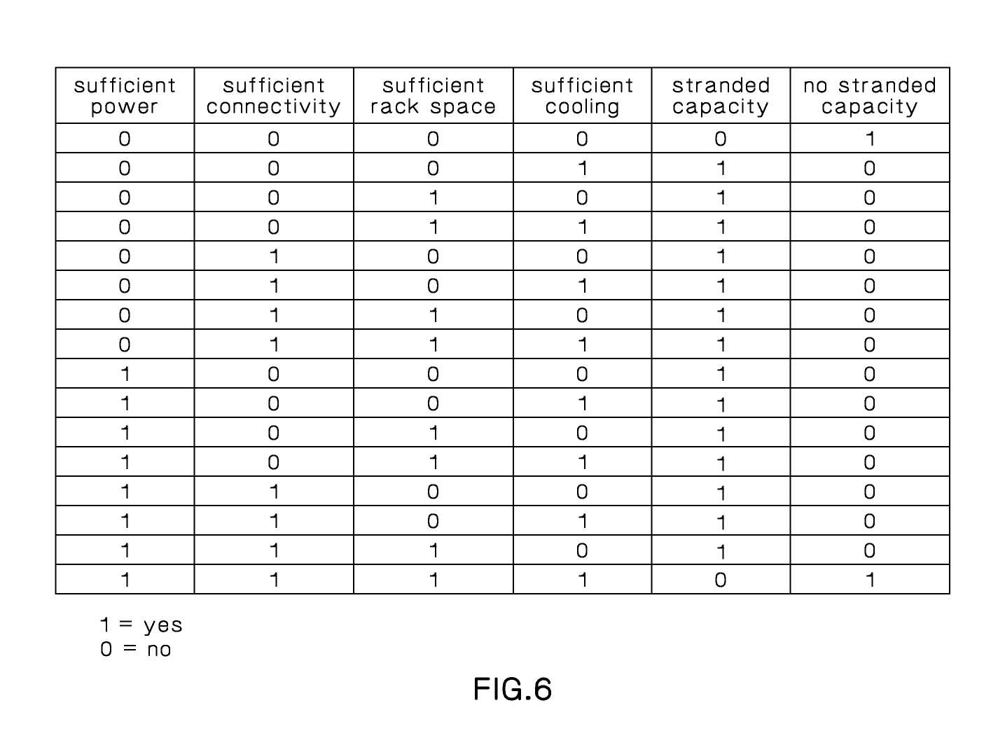

A flowchart for an algorithm 24, according to an embodiment of the present invention, for identifying stranded capacity is illustrated in FIG. 5, and a corresponding truth table for algorithm 24 is illustrated in FIG. 6. Following receiving input from stranded capacity search screen 18 from the user, algorithm 24 is executed to locate stranded capacity. In step S10 all racks/cabinets for the user-identified locations are retrieved. In steps S12-S18 each rack is checked for sufficient power, connectivity, rack space, and cooling. If any one of these checks yields insufficient capacity, then the remaining variables are checked for sufficient capacity in step S20. If one of the remaining capacity variables does have sufficient capacity, then the rack/cabinet has stranded capacity as indicated in step S22 (or conversely no stranded capacity as indicated in step S24) and that stranded capacity added to the display of rack information in a corresponding row in stranded capacity search results screen 20 in step S26. The algorithm repeats for each rack/cabinet in the user-specified location.

Stranded capacity search results screen 20 displays the results of the stranded capacity search and lists of all racks/cabinets within the data center that have stranded capacity. All four capacity variables can be listed in the results along with the location and name of the rack/cabinet. Stranded capacity can be color coded for example and can appear in green in screen 20, and the capacity variables that are causing the stranded capacity can also be color coded and can appear in red in screen 20. Consequently, users, such as data center managers and other cognizant personnel, can clearly see associated stranded capacity and corresponding causes.

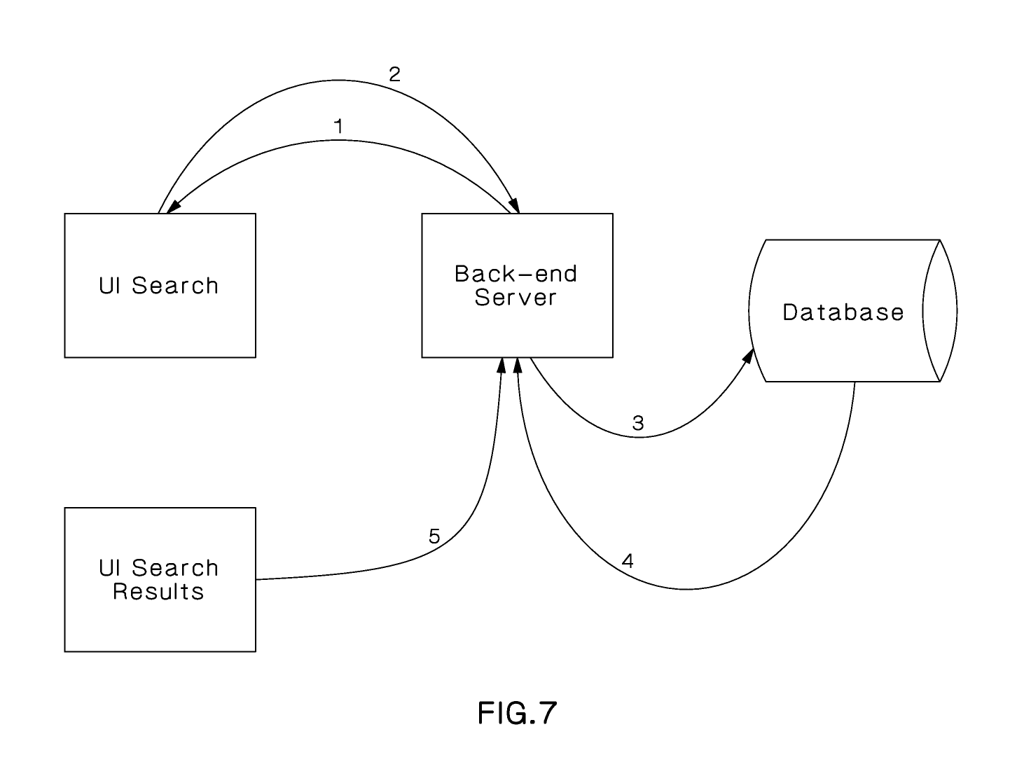

FIG. 7 is an example of system flow diagram according to an embodiment of the present invention. Beginning with Arrow 1, UI search screen, such as stranded capacity search screen 18, is sent to the user from the back-end server 14. The user enters the thresholds for performing a stranded capacity search according to FIG. 5 and then sends the criteria/thresholds (Arrow 2) to back-end server 14. Back-end server 14 executes an algorithm (FIG. 5), which includes reading (Arrow 3) data from database 16, and the database responding (Arrow 4) with data such as in results screen 20. Back-end server 14 then returns (Arrow 5) the search results to the user via the GUI search results screen 20.

Using the present invention, a data center planner can add additional power, switch ports, cooling or free up rack spaces to alleviate the stranded capacity condition. Alternatively, it may be possible to move the stranded capacity to another rack that is able to use the stranded capacity. One example of this is to move connectivity.

Although the previous example evaluates stranded capacity within a data center, the present invention can be applied to other environments where capacity is a concern. Additionally, the previous example discusses capacity in terms of rack space, power, cooling, and connectivity, but can be applied to additional capacity variables. For example, the embodiments of FIGS. 1-7 do not explicitly account for security or additional navigations but the present invention can be so modified within the scope of this disclosure.

Although cooling is expressed in terms of a maximum temperature allowable in the rack, alternate methods of cooling, such as available cooling expressed in watts for example, are permissible under the disclosed method.

Note that while this invention has been described in terms of one or more embodiment(s), these embodiment(s) are non-limiting, and there are alterations, permutations, and equivalents, which fall within the scope of this invention. It should also be noted that there are many alternative ways of implementing the methods and apparatuses of the present invention. It is therefore intended that claims that may follow be interpreted as including all such alterations, permutations, and equivalents as fall within the true spirit and scope of the present invention.

I claim:

1. A data center physical infrastructure management system, the system being managed by IT personnel, the system comprising:
at least one of a rack and a cabinet having rack spaces and at least one sensor;
a data communication arrangement for propagating communications signals from the sensor to a management database that receives information from the communications signals, the received information being stored; and
a data processor for determining algorithmically, from said received information, stranded capacity within said at least one of a rack and a cabinet.

2. The data center physical infrastructure management system of claim 1, further including a plurality of instructions in said management database, said instructions executed by said data processor, said stranded capacity being algorithmically determined from said instructions.

3. The data center physical infrastructure management system of claim 2, wherein said management database includes locations for data center assets and capacities, each said location being associated with one of said rack and said cabinet.

4. The data center physical infrastructure management system of claim 3, wherein said instructions includes recording a plurality of stranded capacity threshold values in the at least one database; retrieving a plurality of the locations for data center assets and capacities; comparing each of the locations for data center assets and capacities with each of the stranded capacity threshold values; determining, for each of the locations, if the comparing step yields at least one insufficient capacity in any of the respective locations; and checking, for each of the locations wherein the determining step identified at least one insufficient capacity, if the comparing step yields at least one sufficient capacity in respective said each of the locations.

5. The system of claim 4, wherein said instructions further includes reporting at least each of the locations for data center assets and capacities which has both at least one insufficient capacity and at least one sufficient capacity.

6. The system of claim 5, further including a graphical user interface for said reporting of said locations for data center assets and capacities which has both at least one insufficient capacity and at least one sufficient capacity.

7. The system of claim 4, further including a graphical user interface for said recording of said plurality of stranded capacity threshold values.

8. A method for determining stranded capacity within a data center, the method using at least one processor connected to at least one database, the at least one database including locations for data center assets and capacities, the method comprising the steps of:
recording a plurality of stranded capacity threshold values in at least one of a memory and the at least one database;
retrieving a plurality of the locations for data center assets and capacities;
comparing each of the locations for data center assets and capacities with each of the stranded capacity threshold values;
determining, for each of the locations, if the comparing step yields at least one insufficient capacity in any of the respective locations; and
checking, for each of the locations wherein the determining step identified at least one insufficient capacity, if the comparing step yields at least one sufficient capacity in respective said each of the locations.

9. The method of claim 8, further including the step of reporting at least each of the locations for data center assets and capacities which has both at least one insufficient capacity and at least one sufficient capacity.

10. The method of claim 9, wherein said reporting step includes a graphical user interface.

11. The method of claim 8, wherein said recording step includes a graphical user interface.

12. The method of claim 8, wherein each of said locations includes one of a rack and a cabinet.

13. A system for determining stranded capacity within a data center, the data center including locations for data center assets and capacities, the system comprising:
at least one processor;
at least one database connected to said at least one processor; and
at least one computer readable medium connected to said at least one processor, the at least one computer readable medium including instructions for recording a plurality of stranded capacity threshold values in the at least one database, retrieving a plurality of the locations for data center assets and capacities, comparing each of the locations for data center assets and capacities with each of the stranded capacity threshold values, determining, for each of the locations, if the comparing step yields at least one insufficient capacity in any of the respective locations, and checking, for each of the locations wherein the determining step identified at least one insufficient capacity, if the comparing step yields at least one sufficient capacity in respective said each of the locations.

14. The system of claim 13, wherein said instructions further includes reporting at least each of the locations for data center assets and capacities which has both at least one insufficient capacity and at least one sufficient capacity.

15. The system of claim 14, further including a graphical user interface for said reporting of said locations for data center assets and capacities which has both at least one insufficient capacity and at least one sufficient capacity.

16. The system of claim 13, further including a graphical user interface for said recording of said plurality of stranded capacity threshold values.

17. The system of claim 13, wherein each of said locations includes one of a rack and a cabinet.

18. The system of claim 13, wherein at least one said computer readable medium is part of at least one said database.
